(19) United States
(12) Patent Application Publication
(10) Pub. No.: US 2010/0024161 A1
(43) Pub. Date: Feb. 4, 2010

(54) Hold Open Rod

(75) Inventors: Matthew Wood, Waco, TX (US); Julio Palma, Waco, TX (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: MARATHONNORCO AEROSPACE, INC., Waco, TX (US)

(21) Appl. No.: 12/555,200

(22) Filed: Sep. 8, 2009

Related U.S. Application Data
(63) Continuation-in-part of application No. 12/135,778, filed on Jun. 9, 2008.

(51) Int. Cl. E05F 5/02

(52) U.S. Cl. 16/82

(57) ABSTRACT

A hold open rod is provided that includes an outer tube, an inner tube, an inner rod, and a friction pad. The inner tube is slidingly disposed within the outer tube and includes a head with an inner bearing surface. The inner rod is slidingly disposed within the inner tube, is secured to one end of the outer tube, and has at least one tapered end portion. The friction pad is captured between the head inner bearing surface and the inner rod.

### CROSS-REFERENCE TO RELATED APPLICATIONS

This application is a continuation-in-part (CIP) of application Ser. No. 12/135,778, entitled “Device And Method Of Mechanically Dampening A Hold Open Rod,” filed on Jun. 9, 2008, the disclosure of which is hereby incorporated by reference in its entirety.

### FIELD OF THE INVENTION

The present invention relates generally to rods, struts, etc. More particularly, the present invention relates to a hold open rod.

### BACKGROUND OF THE INVENTION

Door closers are used to close a door after being opened manually or automatically. Generally, door closers include a cylinder having a piston connected to a piston rod within the cylinder. The piston is normally biased by a compression spring. The opposed ends of the cylinder and the piston rod may be suitably connected between a door frame and its door. The opening of the door causes the piston to be rectilinearly displaced within the inner surface of the cylinder whereby the connected piston rod is extended beyond the end of the cylinder, thereby compressing the spring. The compression spring, acting on the piston in its compressed state, normally functions to return the door to its closed position as the door is released after the opening of the door.

In certain applications, hold open rods are used to control the rate at which a door, a hatch, etc., closes. To control the closing of a door, pneumatic springs or hydraulic-type dampeners have been used to dampen the movement of hold open rods. The retracting momentum of the piston is typically cushioned by compression of fluid, such as air or oil inside the cylinder tube to create a damping resistance opposite the force that propels the door to close for better control of the speed and force at which the door closes.

A known problem regarding known dampeners is that the fluid used in these devices introduces an opportunity for undesirable leakage. In addition, these hydraulics and pneumatics have seals, wipers and o-rings that wear and require frequent maintenance and replacement.

### SUMMARY OF THE INVENTION

Embodiments of the present invention advantageously provide a hold open rod that includes an outer tube, an inner tube, an inner rod, and a friction pad. The inner tube is slidingly disposed within the outer tube and includes a head with an inner bearing surface. The inner rod is slidingly disposed within the inner tube, is secured to one end of the outer tube, and has at least one tapered end portion. The friction pad is captured between the inner bearing surface and the inner rod.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross-sectional view illustrating a door in a closed configuration suitable for use with a hold open rod according to an embodiment of the invention.

FIG. 2 is a cross-sectional view illustrating the door according to FIG. 1 in an open configuration.

FIG. 3 is a cross-sectional view illustrating a hold open rod according to an embodiment of the invention.

FIG. 4 is a partially cutaway perspective view of the hold open rod shown in FIG. 3.

FIG. 5 is a cross-sectional perspective view of the cross-section of the hold open rod shown in FIG. 3.

FIG. 6 is a cross-sectional view of a hold open rod according to another embodiment of the invention.

FIG. 7 is a cross-sectional perspective view of the hold open rod according to the embodiment depicted in FIG. 6.

FIG. 8 is a cross-sectional view of a hold open rod according to another embodiment of the invention.

FIG. 9 is a cross-sectional perspective view of the hold open rod according to the embodiment depicted in FIG. 8.

FIG. 10 is a perspective view of a friction pad according to an embodiment of the invention.

FIG. 11 is an isometric cross-sectional view of the hold open rod according to an embodiment of the invention.

FIG. 12 is an isometric cross-sectional view of a release assembly according to the embodiment depicted in FIG. 11.

FIG. 13 is an isometric cross-sectional view of an end fitting suitable for attachment to a proximal end of the hold open rod.

FIG. 14 is an isometric cross-sectional view of an end fitting suitable for attachment to a distal end of the hold open rod.

### DETAILED DESCRIPTION

The invention will now be described with reference to the drawing figures, in which like reference numerals refer to like parts throughout.

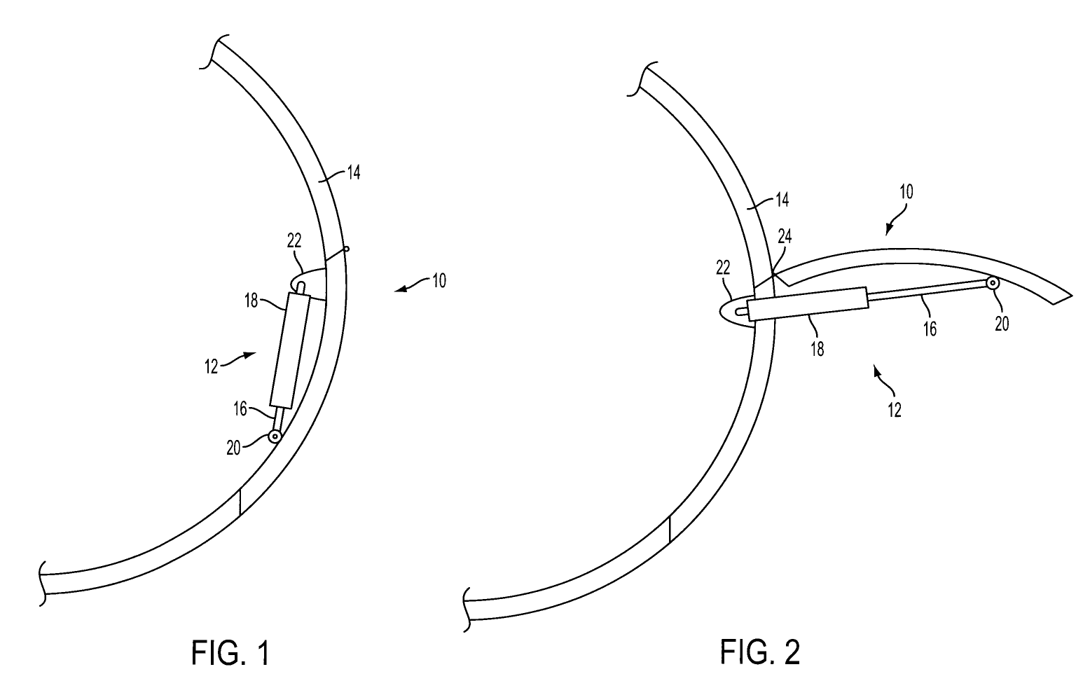

FIG. 1 is a cross-sectional view illustrating a door, hatch, etc., 10 in a closed configuration suitable for use with a hold open rod 12 according to an embodiment of the invention. As shown in FIG. 1, the door 10 may be disposed in a vehicle such as an aircraft, bus, ship, train, or the like. For example, door 10 is disposed in a fuselage of an aircraft. In other examples, the door 10 may be an access panel, cover, cowling, etc., for an engine nacelle, luggage compartment or other such compartment in an aircraft, vehicle, etc. In addition, the hold open rod 12 may be utilized in other structures such as buildings. However, due to the advantageous reduction in weight and ease of maintenance, the hold open rod 12 is particularly useful in aircraft and vehicles. According to a preferred embodiment, hold open rod 12 includes an inner tube 16 and an outer tube 18. Inner tube 16 and outer tube 18 are in axial alignment and slide relative to one another in a telescoping manner.

The hold open rod 12 may be attached to the door 10 by a door fitting 20 pivotally connected to the inner tube 16. The hold open rod 12 may be attached to the fuselage, engine nacelle, etc., by a bracket 22 pivotally connected to the outer tube 18. The converse attachment orientation is also contemplated by the present invention.

As shown in FIG. 2, the door 10, may swing open via a hinge 24, for example. In response to the door 10 being opened, the inner tube 16 may telescope out from the outer tube 18. In the particular example shown, in the open configuration, the door 10 is biased to close at least by gravity acting upon the door 10. In this or other examples, biasing of the door 10 may be provided by a spring or actuator. The hold open rod 12 facilitates maintaining the door 10 in the open configuration by providing resistance. Specifically, the hold open rod 12 provides resistance to the inner tube 16 sliding into the outer tube 18.

While FIGS. 1 and 2 show the hold open rod 12 retracted in response to the door 10 being in a closed configuration and extended in response to the door 10 being in an open configuration, in other examples the hold open rod 12 may be extended in response to the door 10 being closed. That is, depending upon where the hold open rod 12 is attached to the door 10 and/or a frame of the door 10, the bias of the door 10, the addition of any suitable linkage or linkages, the hold open rod 12 may be configured to extend or retract in response to the door 10 being opened or closed.

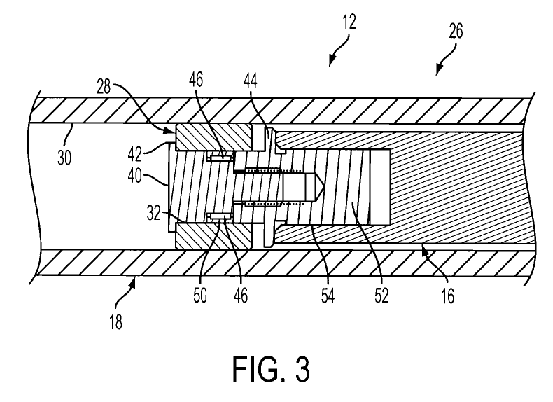

FIG. 3 is a cross-sectional view illustrating a hold open rod 12 according to an embodiment of the invention. One or more friction pads 28 are disposed between an inner surface 30 of the outer tube 18 and an outer surface 32 of the inner tube 16. When the hold open rod 12 is in use, the friction pads 28 are squeezed between the inner surface 30 and the outer surface 32 with sufficient force to generate a predetermined amount of frictional resistance to the sliding motion of the outer tube 18 relative to the inner tube 16. In this manner, movement of the outer tube 18 relative to the inner tube 16 may be dampened or stopped.

The inner tube 16 also includes a head 40 to retain the friction pads 28. The head 40 includes a pair of pad retaining flanges 42 and 44 to retain the friction pads 28 therebetween. The head 40 further includes a pad seat 46. In an embodiment of the invention, the pad seat 46 includes a tapered annular surface that tapers radially outwardly at angle θ. The angle θ may include any suitable angle such as about 1° to about 7°. In various embodiments, the inner bearing surface of pad seat 46 may be straight, tapered or frusta-conical. In use, as the inner tube 16 is moved in direction “A” relative to the outer tube 18, friction acting between the friction pads 28 and the inner surface 30 urges the friction pads 28 in direction “B” relative to the inner tube 16. As the friction pads 28 traverse the pad seat 46 in direction “B”, the friction pads 28 are squeezed between the inner surface 30 and the outer surface 32 to a greater extent. Optionally, the friction pads 28 may also be tapered or frusta-conically shaped. For example, the friction pads 28 may also be tapered at angle θ.

Additionally, the hold open rod 12 may optionally include a spring 50 disposed in a spring retaining seat 52. If included, the spring 50 may be disposed between the spring retaining seat 52 and the friction pads 28 to urge the friction pads 28 radially, outwardly. In a particular embodiment, the spring 50 includes an elastomeric annular ring having one or more flange portions that act as resilient members to urge the friction pads 28 radially, outwardly.

In various embodiments of the invention, the head 40 of the inner tube 16 may be removably or threadedly attached to the inner tube 16 via a threaded insert 52. This allows for the head 40 and the threaded insert to be made from a different material than the inner tube 16. For example, the inner tube 16 may include an aluminum, magnesium, and/or titanium alloy to reduce weight while the head 40 may include a stainless steel and/or bronze alloy to provide wear, strength, and/or machining properties. In some embodiments, a portion of the inner tube 16 may be hollow. This may reduce weight and/or enable the manufacturing and maintenance of the hold open rod 12 to be cost efficient. In other embodiments, however, the inner tube 12 may be one solid piece of material.

In one embodiment, pad seat 46 tapers radially outwardly at angle θ. Again, the friction pads 28 may, optionally, also be tapered at angle θ, which is based on a variety of factors such as, for example, modulus of elasticity of the friction pads 28, frictional coefficient between the friction pads 28 and the inner surface 30, the frictional coefficient between the friction pads 28 and the outer surface 32, the expected load on the hold open rod 12, the predetermined amount of frictional resistance, empirical data, and the like. For example, the pad seat 46 may taper radially outwardly at both ends or may taper radially inwardly at both ends from about a center portion of the pad seat 46.

In response to the door being opened or closed, the inner tube 16 is moved with respect to the outer tube 18 in a telescoping manner. As the tubes move axially, friction urges the friction pad 28 to translate along the pad seat 46. This translation of the friction pad 28 is again opposed by friction. In a particular example, in response to the inner tube 16 moving in direction “A” with respect to outer tube 18, the friction urges the friction pad 28 to translate along the pad/tube interface. As the friction pad 28 translates along the tapered pad seat 46, a gap or distance separating the inner surface 30 from the outer surface 32 is reduced. The compression of the friction pads 28 provides friction between the friction pads 28 and inner tube 16 outer wall, thereby creating a dampening effect to slow or stop the movement of the telescoping tubes. In general, a transverse load, such as the friction pads 28 being urged outwardly, is produced from an axial force resulting from extending and/or retracting of the hold open rod 12. In a particular example, the dampening effect is sufficient to hold the door 10 (shown in FIGS. 1 and 2) open against the bias of the door 10 but not so great to hamper closing of the door 10 by an operator, for example.

If included, the optional spring 50 may further urge the friction pads 28 outwards and against the inner surface 30. This outward urging of the spring 50 may maintain the outward thrust of the friction pads 28 against the inner surface 30 at a predetermined minimum amount of outward thrust. In turn, this predetermined minimum amount of outward thrust acts to “pre-load” the friction pads 28 against the inner surface 30. In addition, the elastic properties or the spring 50 may offset thinning of the friction pads 28 due to abrasion, for example.

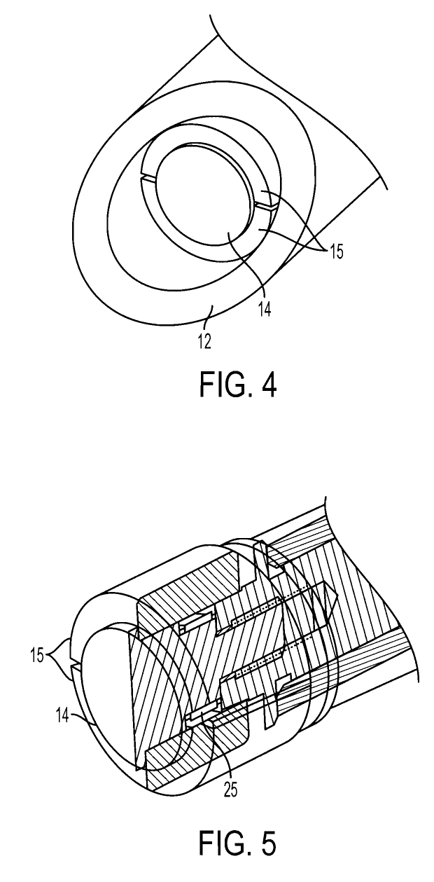

FIG. 4 is a partially cutaway perspective view of the hold open rod 12 shown in FIG. 1. As shown in FIG. 4, the friction pads 28 may include two complimentary halves which encase the outer surface of the inner tube 16. In response to these complimentary halves of the friction pads 28 being urged apart and against the inner surface 30, the resistance to the sliding motion of the inner tube 16 relative to the outer tube 18 may be increased. In this manner, the hold open rod 12 may be used to control the rate at which the door 10 opens and/or closes.

FIG. 5 is a cross-sectional perspective view of the mechanical dampening device shown in FIG. 3. The shape and material of the friction pads 28 and tube head 40 control the coefficient of friction and therefore, control the dampening feature of the hold open rod 12. The friction pads 28 may be shaped to complement the outer surface of the head 40 such that the desired dampening occurs. As appreciated by one of ordinary skill in the art, the friction pads 28 may be made of an elastomeric material, such as ethylene vinyl acetate, for example.

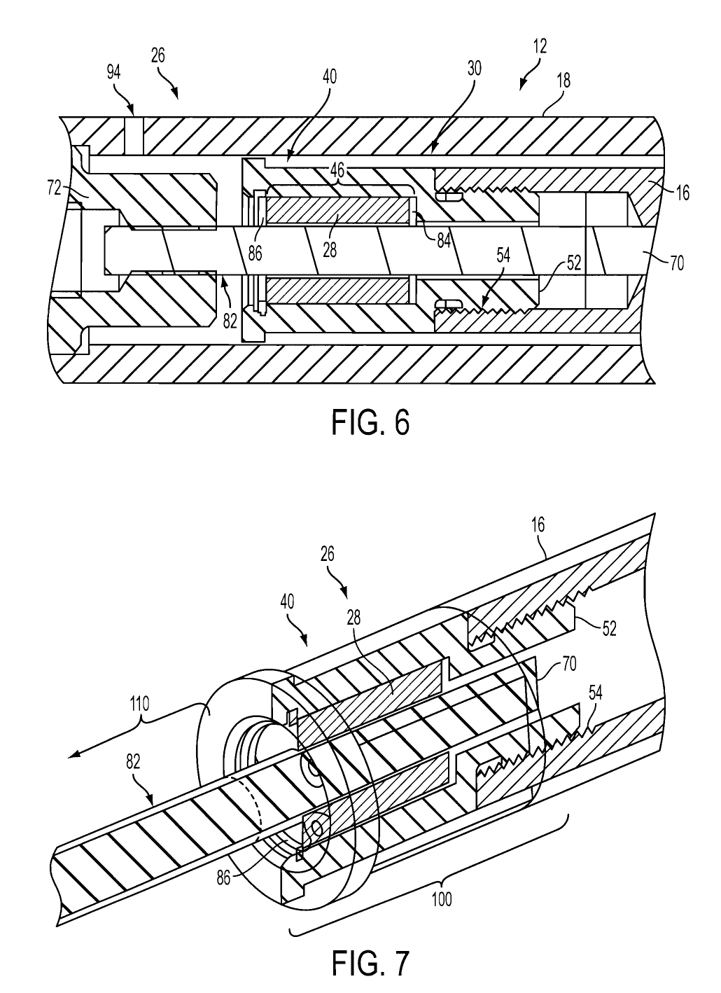

FIG. 6 is a cross-sectional view illustrating hold open rod 12 according to another embodiment. In this embodiment, hold open rod 12 includes an outer tube 18, an inner tube 16 and an inner rod 70. The inner rod 70 is secured to the outer tube 18 via a adapter 72. Specifically, the proximal end of the inner rod 70 is secured in the adapter 72 and the adapter 72 is secured at or near the proximal end of the outer tube 18.

In use, the outer tube 18 and inner rod 70 move in unison and the inner tube 16 telescopes between them. In a manner similar to the embodiment shown in FIG. 3, movement of the inner tube 16 relative to the outer tube 18 generates a transverse load on the friction pad 28 or otherwise compresses the friction pad 28 which increases frictional resistance. In the embodiment shown in FIG. 6, the inner rod 70 is tapered at least at one end, such that as the friction pad 28 is drawn along the inner rod 70, the increasing diameter of the inner rod 70 urges the friction pad 28 radially outwards.

As further shown in FIG. 6, the friction pad 28 is captured between the inner rod 70 and an inner bearing surface 80 of head 40. As such, as the friction pad 28 is translated along inner rod 70 and driven outwardly, the friction pad 28 is compressed between the inner bearing surface 80 and an outer rod surface 82.

To retain the friction pad 28 within the head 40, in one embodiment, a pad seat 46 includes the inner bearing surface 80, a seat land 84 and a retaining ring 86. To retain the head 40 at the proximal end of the inner tube 16, the head 40 may include a threaded region 90 to mate with a tapped bore 92 disposed in the inner tube 16. Also shown in FIG. 6, the outer tube 18 may include one or more ports 94 to allow for the ingress and/or egress of air. If included, these ports 94 may reduce or prevent the generation of a partial vacuum or pressurized air that may interfere with the operation of the hold open rod 12. In addition, the ports 94 may facilitate the egress of condensate.

FIG. 7 is a cross-sectional perspective view of the hold open rod 12 at the distal end of the inner rod 70. For the sake of clarity, the outer tube 18 has been removed. As shown in FIG. 7, the distal end of the inner rod 70 may also be tapered at region 100. The tapered region 100 may facilitate retaining the hold open rod 12 in an open or extended configuration. At region 110, the inner rod 70 may be relatively straight sided. In this manner, frictional resistance generated by friction pads 28 may remain relatively constant through some portion of the travel. The tapered region 100 confers several advantages; for example, tapered region 100 facilitates assembly because an outer diameter of the inner rod 70 at the distal end is less than an inner diameter of the friction pads 28. Another advantage is that initial frictional resistance may be reduced to facilitate ease of closing the door 10 (shown in FIGS. 1 and 2). That is, at a fully extended configuration, the reduced diameter of the inner rod 70 may exert relatively less frictional resistance as compared to the frictional resistance as the hold open rod 12 is retracted. If the frictional resistance is insufficient to hold the door 10 against the bias of the door 10, the door 10 may continue to close until the bias and the frictional resistance are in equilibrium. From this state of equilibrium, a relatively small amount of closing force will initiate closing the door 10. Another advantage is that an operational state of the hold open rod 12 may be determined based upon the point in the swing of the door 10 at which the state of equilibrium occurs. For example, if the friction pads 28 loose some thickness due to wear, the state of equilibrium may occur further from the distal end of the inner rod 70. As such, the state of operation of the hold open rod 12 may be readily determined by personnel without the need of testing equipment.

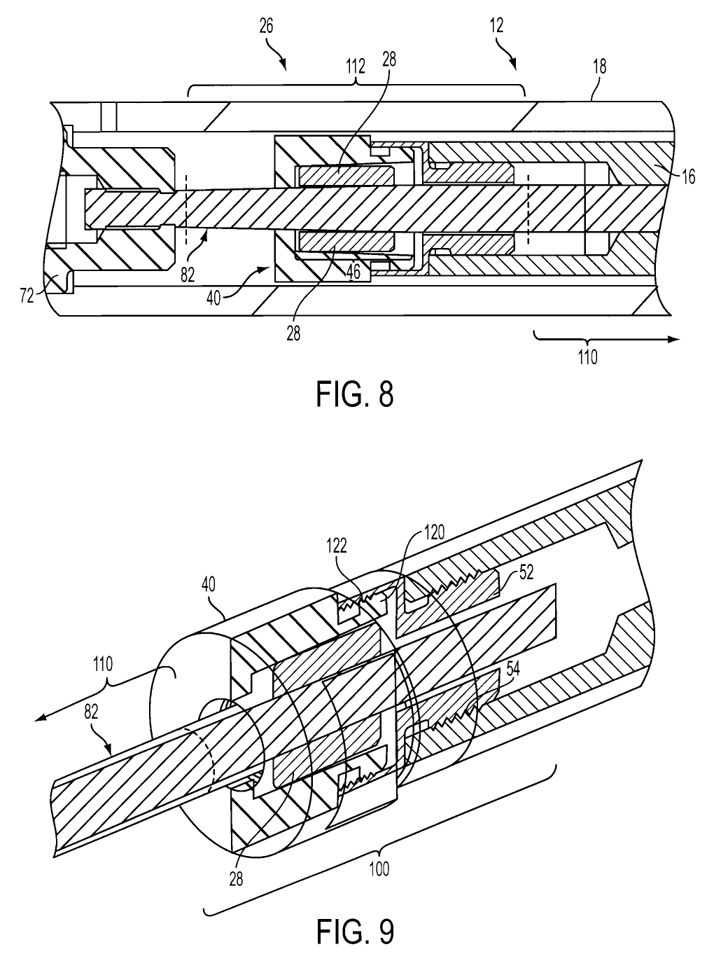

FIG. 8 is a cross-sectional view of the hold open rod 12 according to another embodiment of the invention. As shown in FIG. 8, the friction pads 28 provides frictional resistance to extension of the hold open rod 12 and relatively less frictional resistance to retraction of the hold open rod 12. To generate this frictional resistance, the pad seat 46 is frusta-conical; compression of the friction pads 28 occurs during extension of the hold open rod 12.

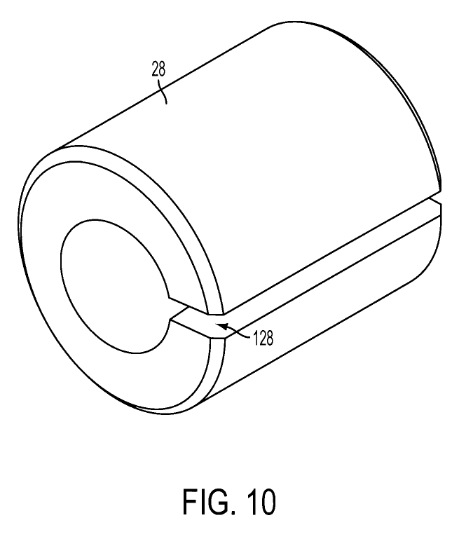

FIG. 9 is a cross-sectional perspective view of the hold open rod 12 depicted in FIG. 8. Threaded region 120 mates with tapped bore 122, thereby facilitating disassembly, servicing or replacing the friction pads 28, and re-assembly. In this and other embodiments, the head 40 includes retaining ring 64 (shown in FIG. 7), set screw, or the like to facilitate servicing the friction pads 28.

FIG. 10 is a perspective view of the friction pad of the hold open rod 12 according to an embodiment of the invention. As shown in FIG. 10, friction pads 28 may be a single friction pad. In the embodiment shown in FIG. 10, the friction pad 28 may include a slit 128 to accommodate expansion/contraction of the pad seat 46/inner rod 70.

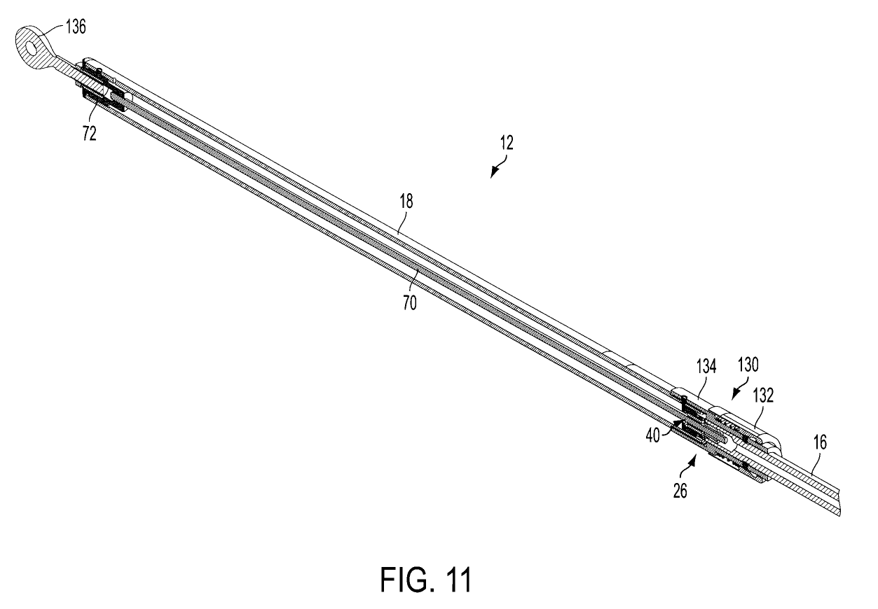

FIG. 11 is an isometric cross-sectional view of the hold open rod 12 according to an embodiment of the invention. Hold open rod 12 includes a release assembly 130 including a release collar 132 and lock body 134, and a fitting 136 to secure the hold open rod 12 to bracket 22. In various embodiments, fitting 136, such as an eye bolt or the like, may be threaded, press fit, or otherwise secured to the adapter 72.

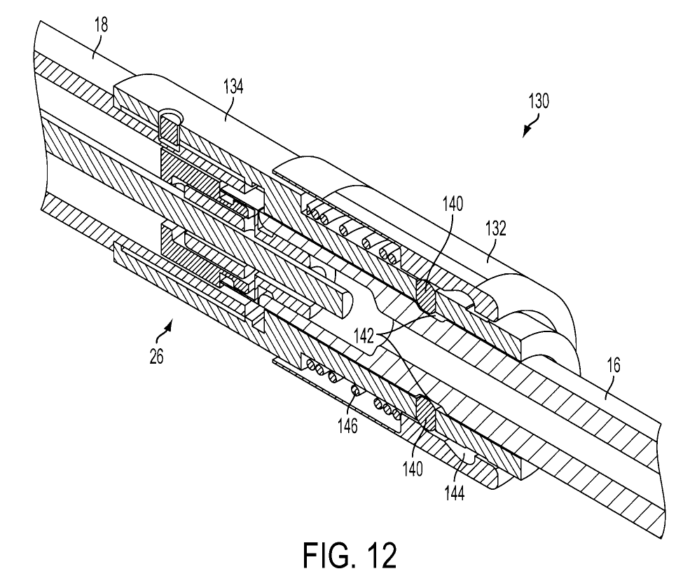

FIG. 12 is an isometric cross-sectional view of the release assembly 130 according to the embodiment shown in FIG. 1. When disposed in a ‘locked configuration’, the release collar 132 retains one or more locking dogs 140 into a dog groove 142. The dog groove 142 is disposed about the inner tube 16. The release collar 132 further includes a release groove 144. In response to the release collar 132 being in an ‘unlocked configuration’ the release groove 144 is disposed cooperative alignment with the locking dogs 140 to allow the locking dogs 140 to slide out of the dog groove 142. In this manner, the inner tube 16 is allowed to retract into the outer tube 18. To bias the release collar 132 in the locked configuration, the release assembly 130 may include a spring 146. To release the release assembly 130, the release collar 132 is urged to slide relative to the release body 134 against the bias of the spring 146. While in the release configuration, the inner tube 16 may be allowed to slide relative to the outer tube 18.

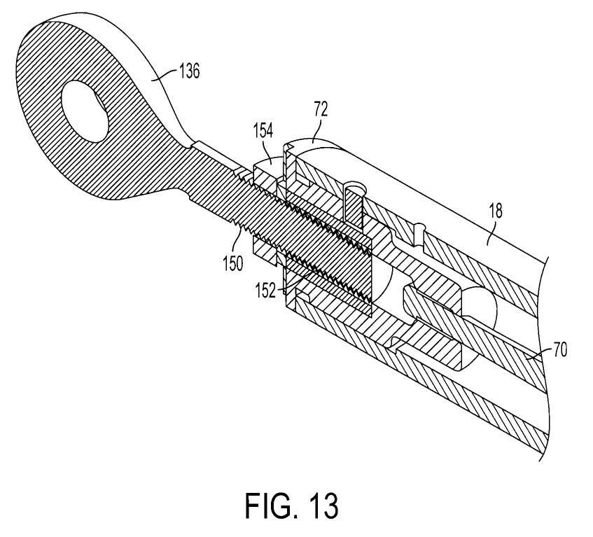

FIG. 13 is an isometric cross-sectional view of an end fitting suitable for attachment to a proximal end of the hold open rod 12. Fitting 136 is secured in the adapter 72. In various examples, fitting 136 may include any suitable end fitting for attachment to the door 10 or a frame of the door 10. Examples of suitable end fittings include eye bolts, rod end bearings, universal joints, clevis pins, and the like. Fitting 136 may be secured to the adapter 72 in any suitable manner. For example, fitting 136 may be threaded into a tapped bore, press fit, locked via a set screw, and/or the like. In the particular example shown, the fitting 136 includes a threaded region 150 to mate with a tapped bore 152. To further secure the fitting 136 in the adapter 72, a locking nut 154 may be utilized.

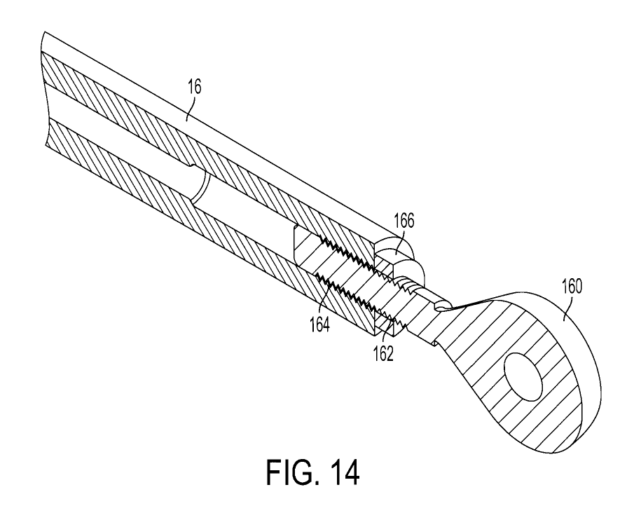

FIG. 14 is an isometric cross-sectional view of an end fitting suitable for attachment to a distal end of the hold open rod 12. As shown in FIG. 14, fitting 160 is secured to the distal end of the inner tube 16. In various examples, the fitting 160 may include any suitable end fitting for attachment to the door 10 or a frame of the door 10. Examples of suitable end fittings include eye bolts, rod end bearings, universal joints, clevis pins, and the like. The fitting 160 may be secured to the inner tube 16 in any suitable manner. For example, the fitting 160 may be threaded into a tapped bore, press fit, locked via a set screw, and/or the like. In the particular example shown, the fitting 160 includes a threaded region 162 to mate with a tapped bore 164. To further secure the fitting 160 in the inner tube 16, a locking nut 166 may be utilized.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A hold open rod, comprising:
an outer tube;
an inner tube, slidingly disposed within the outer tube, including a head having an inner bearing surface;
an inner rod, slidingly disposed within the inner tube and secured to one end of the outer tube, having at least one tapered end portion; and
a friction pad captured between the inner bearing surface and the inner rod.

2. The hold open rod according to claim 1, wherein the friction pad generates a variable resistance over at least the tapered end portion of the inner rod.

3. The hold open rod according to claim 1, wherein the inner rod has two tapered end portions.

4. The hold open rod according to claim 3, wherein the friction pad generates a variable resistance over each tapered end portion.

5. The hold open rod according to claim 1, wherein the inner bearing surface is frusta-conical.

6. The hold open rod according to claim 5, wherein the friction pad generates a variable resistance over the inner rod.

7. The hold open rod according to claim 1, wherein the tapered end portion is frusta-conical.

8. The hold open rod according to claim 1, wherein the head includes a friction pad seat land and a retaining ring, and the friction pad is longitudinally displaceable between the friction pad seat land and the retaining ring.

9. The hold open rod according to claim 1, wherein the head is removably attached to the inner tube.

10. The hold open rod according to claim 1, wherein the friction pad is an elastomeric material.

11. The hold open rod according to claim 1, wherein the outer tube includes a release assembly operable between a locked position and an unlocked position.

12. The hold open rod according to claim 11, wherein:
the inner tube includes a dog groove; and
the release assembly includes a release collar with a release groove, and a lock body with a locking dog to engage the dog groove in the locked position and to engage the release groove in the unlocked position.

13. The hold open rod according to claim 1, wherein the outer rod is attached to an aircraft engine nacelle, and the inner tube is attached to a hinged cowling.

14. A hold open rod, comprising:
an outer tube;
an inner tube, slidingly disposed within the outer tube, including a head having an inner bearing surface;
an inner rod slidingly disposed within the inner tube and secured to one end of the outer tube; and
a means for generating friction captively disposed between the inner bearing surface and the inner rod.

15. The hold open rod according to claim 14, wherein the means for generating friction is longitudinally displaceable within the head.

16. The hold open rod according to claim 15, wherein the inner rod includes at least one tapered end portion, and the means for generating friction generates a variable resistance over the tapered end portion.

17. The hold open rod according to claim 16, wherein the inner bearing surface is frusta-conical, and the means for generating friction generates a variable resistance over the inner rod.

18. The hold open rod according to claim 14, wherein the outer tube includes a means for locking the hold open rod in a locked position.

19. The hold open rod according to claim 18, wherein the inner tube includes a dog groove, and the means for locking includes a means for engaging the dog groove in the locked position.

20. The hold open rod according to claim 19, wherein the means for engaging the dog groove disengages the dog groove in the unlocked position.
